(19) United States
(12) Patent Application Publication
(10) Pub. No.: US 2010/0206139 A1
(43) Pub. Date: Aug. 19, 2010

(54) Tool Assembly

(76) Inventors: Yen Chih Wang, Taoyuan City (TW); Ying-Chieh Ho, Taichung County (TW); I-Hsiu Chen, Shanghai City (CN)

Correspondence Address: Dr. BANGER SHIA;Patent Office of Bang Shia, 102 Lindencrest Ct, Sugar Land, TX, 77479-5201, US

(21) Appl. No.: 12/372,703

(22) Filed: Feb. 17, 2009

(51) Int. Cl. B25B 23/16

(52) U.S. Cl. 81/177.2

(57) ABSTRACT

A tool assembly includes a plurality of bolts each having a head and a shank extending from the head in an axial direction. The head of each bolt includes a groove opposed to the shank. The grooves of the bolts are of differing depths in the axial direction. The groove of each bolt includes a polygonal recessed section and a conical section extending from the recessed section away from the shank and having increasing diameters away from the shank. The conical section includes inner walls at an acute angle with the axial direction. The recessed sections of the bolts are of identical conicity but of different lengths in the axial direction. A driver includes an operative end having a first polygonal driving portion of a size corresponding to the recessed section of each bolt and a conical driving portion of a size and conicity corresponding to the conical section of each bolt.

### BACKGROUND OF THE INVENTION

1. Field of the Invention

The present invention relates to a tool assembly and, more particularly, to a tool assembly including a driver and a plurality of bolts that have differing sizes and that can be driven by the driver while providing suitable torque and operational stability.

2. Description of the Related Art

Typical Allen bolts include hexagonal grooves of differing sizes and depths, so that a plurality of Allen wrenches of differing sizes is required to fasten or unfasten these differing Allen bolts. However, management of the large number of the Allen bolts and Allen wrenches is not easy. Furthermore, a user must purchase the whole set of Allen wrenches even if only one of them is lost. Further, when working on an object having Allen bolts of different sizes, a lot of time is wasted on changing the Allen wrenches. Further, the more number of Allen wrenches is required, the more burden is caused to the environment under the circumstances of global shortage of energy, high price of steel, and serious environmental pollution.

Thus, a need exists for a tool assembly including a plurality of Allen bolts that can be driven by a single driver.

### BRIEF SUMMARY OF THE INVENTION

The primary objective of the present invention is to provide a tool assembly including a driver and a plurality of bolts that have differing sizes and that can be driven by the driver while providing suitable torque and operational stability.

A tool assembly according to the preferred teachings of the present invention includes a plurality of bolts of differing sizes and each including a head and a shank extending from a side of the head in an axial direction. The head of each of the plurality of bolts includes a groove opposed to the shank. The grooves of the bolts are of differing depths in the axial direction. The groove of each of the plurality of bolts includes a polygonal recessed section having a plurality of inner walls extending in the axial direction. Each of the plurality of bolts further includes a conical section extending from the recessed section away from the shank and having increasing diameters away from the shank. The conical section includes a plurality of inner walls at an acute angle with the axial direction. The recessed sections of the plurality of bolts are of identical conicity but of different lengths in the axial direction. A driver includes a handle and an operative end releasably engageable with the groove of any one of the plurality of bolts. The operative end includes a first polygonal driving portion of a size corresponding to the recessed section of each of the plurality of bolts. The operative end further includes a conical driving portion of a size and conicity corresponding to the conical section of each of the plurality of bolts.

The operative end of the driver is insertable into the groove of any one of the bolts, with the first polygonal driving portion engaged in the recessed section, with a perimeter wall of the first polygonal driving portion abutting the inner walls of the recessed section, with the conical driving portion of the driver engaged in the conical section, and with a perimeter wall of the conical driving portion abutting the inner walls of the conical section.

In the most preferred form, the largest one of the plurality of bolts further includes a polygonal outer recessed section extending from the conical section away from the recessed section. The outer recessed section includes a plurality of inner walls extending in the axial direction. Furthermore, the operative end further includes a second polygonal driving portion of a size corresponding to the polygonal outer recessed section. Further, the smallest one of the plurality of bolts is free of the conical section.

The present invention will become clearer in light of the following detailed description of an illustrative embodiment of this invention described in connection with the drawings.

### DESCRIPTION OF THE DRAWINGS

FIG. 1 shows a perspective view of a tool assembly according to the preferred teachings of the present invention.

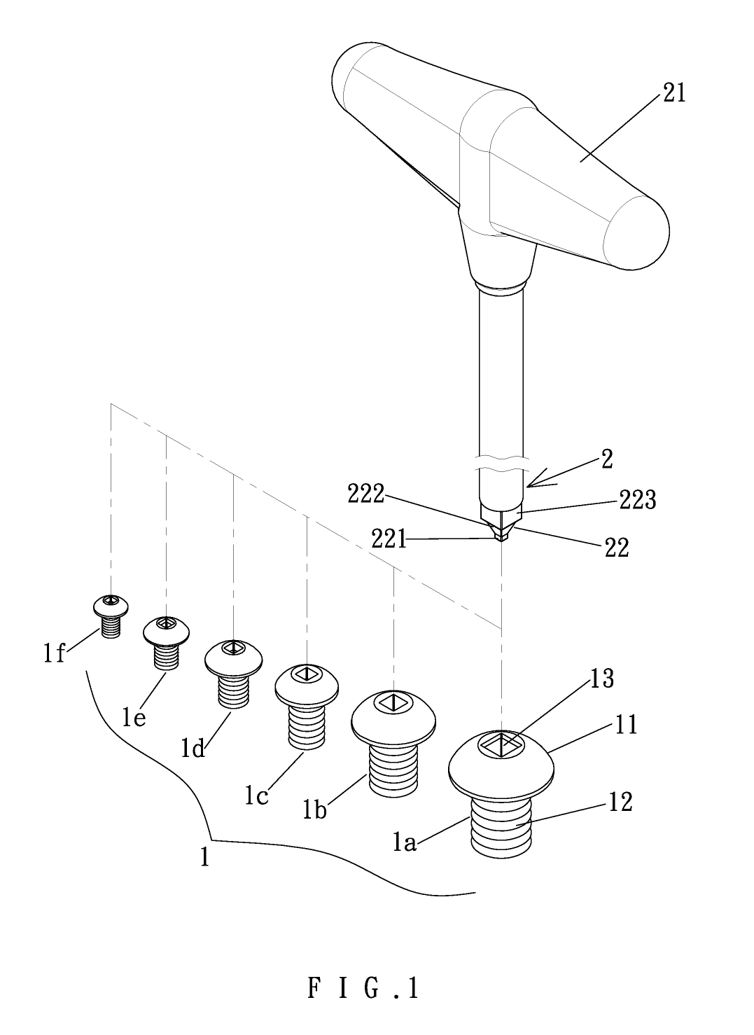

FIG. 2 shows cross sectional views of a plurality of bolts of the tool assembly of FIG. 1.

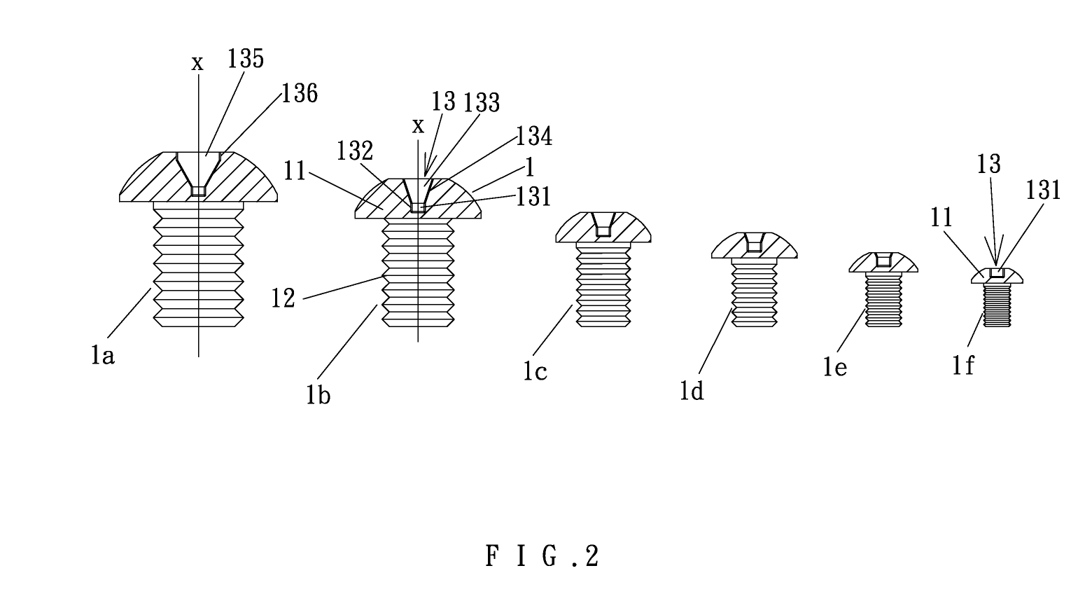

FIG. 3 is shows cross sectional views illustrating use of a driver with each of the bolts of FIG. 2.

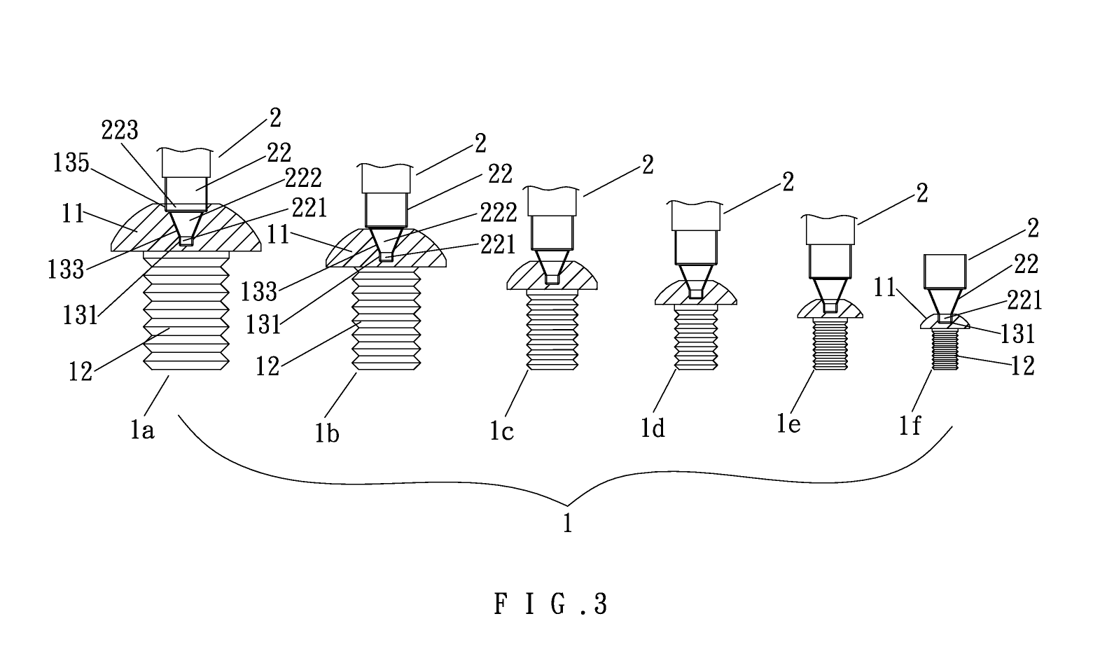

### DETAILED DESCRIPTION OF THE INVENTION

A tool assembly according to the preferred teachings of the present invention is shown in the drawings and generally includes a plurality of bolts 1 and a driver 2 for driving the bolts 1. The bolts 1 are of differing sizes such as M₂-M₂₀ sizes. In the preferred form shown, the tool assembly includes six bolts 1a-If each having a head 11 and a shank 12 extending from a side of the head 11 in an axial direction X. The head 11 includes a groove 13 opposed to the shank 12. The grooves 13 of the bolts 1a-1f are of differing depths in the axial direction X. The groove 13 of each bolt 1a-1f has a polygonal recessed section 131 having a plurality of inner walls 132 extending in the axial direction X. Furthermore, each of the bolts 1a-1e has a conical section 133 extending from the recessed section 131 away from the shank 12 and having increasing diameters away from the shank 12. The conical section 133 includes a plurality of inner walls 134 at an acute angle with the axial direction X. Note that the smallest bolt 1f does not include the conical section 133, since the head 11 has a small thickness in the axial direction X. The recessed sections 131 of the bolts 1a-If are of the same conicity but have different lengths in the axial direction X.

In the most preferred form shown, the largest bolt 1a further includes a polygonal outer recessed section 135 extending from the conical section 133 away from the recessed section 131. The outer recessed section 135 includes a plurality of inner walls 136 extending in the axial direction X.

According to the preferred form shown, the driver 2 includes a handle 21 and an operative end 22 releasably engageable with the groove 13 of any one of the bolts 1a-1f. The operative end 22 includes a first polygonal driving portion 221 of a size corresponding to the recessed section 131 of each bolt 1a-1f. The operative end 22 further includes a conical driving portion 222 of a size and conicity corresponding to the conical section 133 of each of the bolts 1a-1e. The operative end 22 further includes a second polygonal driving portion 223 of a size corresponding to the polygonal outer recessed section 135.

In use, the operative end 22 of the driver 2 can be inserted into the groove 13 any one of the bolts 1a-If of differing depths, with the first polygonal driving portion 221 engaged in the recessed section 131, and with a perimeter wall of the first polygonal driving portion 221 abutting the inner walls 132 of the recessed section 131. When the driver 2 is utilized with any one of the bolts 1a-1e, the conical driving portion 222 of the driver 2 is engaged in the conical section 133, with a perimeter wall of the conical driving portion 222 abutting the inner walls 134 of the conical section 133. A larger torque is provided between the driver 2 and the bolt 1a-1e. Note that the first polygonal driving portion 221 engaged in the recessed section 131 improves the engaging effect between the operative end 22 and the groove 13, preventing the operative end 22 from disengaging from the groove 13 when the driver 2 is rotated. It can be appreciated that since the bolt 1f of a smaller size can be driven by a smaller torque, coupling between the recessed section 131 and the first polygonal driving portion 221 is sufficient to provide the desired torque. When the driver 2 is utilized with the largest bolt 1a, in addition to coupling between the first polygonal driving portion 221 and the recessed section 131 and coupling between the conical driving portion 222 and the conical section 133, the second polygonal driving portion 223 of the driver 2 is engaged in the outer recessed section 135, providing larger torque for driving bolt 1a.

The tool assembly according to the preferred teachings of the present invention allows use of a single driver 2 to drive a plurality of bolts 1 of differing sizes without the need of changing the driver 2 while allowing easy management of the tool assembly and cutting the costs of the tool assembly.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A tool assembly comprising:
a plurality of bolts of differing sizes and each including a head and a shank extending from a side of the head in an axial direction, with the head of each of the plurality of bolts including a groove opposed to the shank, with the grooves of the plurality of bolts being of differing depths in the axial direction, with the groove of each of the plurality of bolts including a polygonal recessed section having a plurality of inner walls extending in the axial direction, with each of the plurality of bolts further including a conical section extending from the recessed section away from the shank and having increasing diameters away from the shank, with the conical section including a plurality of inner walls at an acute angle with the axial direction, with the recessed sections of the plurality of bolts being of identical conicity but of different lengths in the axial direction; and
a driver including a handle and an operative end releasably engageable with the groove of any one of the plurality of bolts, with the operative end including a first polygonal driving portion of a size corresponding to the recessed section of each of the plurality of bolts, with the operative end further including a conical driving portion of a size and conicity corresponding to the conical section of each of the plurality of bolts,
wherein the operative end of the driver is insertable into the groove of any one of the plurality of bolts, with the first polygonal driving portion engaged in the recessed section, with a perimeter wall of the first polygonal driving portion abutting the inner walls of the recessed section, with the conical driving portion of the driver engaged in the conical section, and with a perimeter wall of the conical driving portion abutting the inner walls of the conical section.

2. The tool assembly as claimed in claim 1, with a largest one of the plurality of bolts further including a polygonal outer recessed section extending from the conical section away from the recessed section, with the outer recessed section including a plurality of inner walls extending in the axial direction, with the operative end further including a second polygonal driving portion of a size corresponding to the polygonal outer recessed section.

3. A tool assembly comprising:
a plurality of bolts of differing sizes and each including a head and a shank extending from a side of the head in an axial direction, with the head of each of the plurality of bolts including a groove opposed to the shank, with the grooves of the plurality of bolts being of differing depths in the axial direction, with the groove of each of the plurality of bolts including a polygonal recessed section having a plurality of inner walls extending in the axial direction, with each of the plurality of bolts excluding a smallest one of the plurality of bolts further including a conical section extending from the recessed section away from the shank and having increasing diameters away from the shank, with the conical section including a plurality of inner walls at an acute angle with the axial direction, with the recessed sections of the plurality of bolts excluding the smallest one of the plurality of bolts being of identical conicity but of different lengths in the axial direction; and
a driver including a handle and an operative end releasably engageable with the groove of any one of the plurality of bolts, with the operative end including a first polygonal driving portion of a size corresponding to the recessed section of each of the plurality of bolts, with the operative end further including a conical driving portion of a size and conicity corresponding to the conical section of each of the plurality of bolts excluding the smallest one of the plurality of bolts,
wherein the operative end of the driver is insertable into the groove of any one of the plurality of bolts, with the first polygonal driving portion engaged in the recessed section, with a perimeter wall of the first polygonal driving portion abutting the inner walls of the recessed section, with the conical driving portion of the driver engaged in the conical section, and with a perimeter wall of the conical driving portion abutting the inner walls of the conical section.

4. The tool assembly as claimed in claim 3, with a largest one of the plurality of bolts further including a polygonal outer recessed section extending from the conical section away from the recessed section, with the outer recessed section including a plurality of inner walls extending in the axial direction, with the operative end further including a second polygonal driving portion of a size corresponding to the polygonal outer recessed section.
